(19) United States
(12) Patent Application Publication
(10) Pub. No.: US 2025/0217739 A1
(43) Pub. Date: Jul. 3, 2025

(54) INFORMATION PROCESSING APPARATUS, NON-TRANSITORY COMPUTER READABLE MEDIUM, AND INFORMATION PROCESSING METHOD

(71) Applicant: TOYOTA JIDOSHA KABUSHIKI KAISHA, Toyota-shi (JP)

(72) Inventors: Tomiyasu ISHIKAWA, Okazaki-shi (JP); Tadashi MATSUI, Kasugai-shi (JP); Takumi KOZAWA, Nagoya-shi (JP); Yuto MOTOYAMA, Nagoya-shi (JP); Tsuyoshi OKADA, Nagoya-shi (JP); Yoshiaki MASUYA, Inazawa-shi (JP)

(73) Assignee: TOYOTA JIDOSHA KABUSHIKI KAISHA, Toyota-shi (JP)

(21) Appl. No.: 19/002,009

(22) Filed: Dec. 26, 2024

(30) Foreign Application Priority Data
Dec. 28, 2023 (JP) 2023-223175

(51) Int. Cl. G06Q 10/0631; G06Q 10/0835; G06Q 30/0204

(52) U.S. Cl. CPC G06Q 10/06315; G06Q 10/0835; G06Q 30/0204

(57) ABSTRACT

An information processing apparatus includes a controller configured to acquire user information regarding a user who has purchased a vehicle, generate at least one content according to the user information, and transmit the content to a terminal apparatus of the user at a predetermined timing, in a period of time from when the vehicle has arrived at a dealer until when the vehicle is delivered to the user.

### CROSS-REFERENCE TO RELATED APPLICATION

This application claims priority to Japanese Patent Application No. 2023-223175 filed on Dec. 28, 2023, the entire contents of which are incorporated herein by reference.

### TECHNICAL FIELD

The present disclosure relates to an information processing apparatus, a program, and an information processing method.

### BACKGROUND

Systems that provide users, who have purchased vehicles, with information on the progress of manufacturing of the vehicles the users have purchased are conventionally known.

For example, Patent Literature (PTL) 1 discloses a system that provides a user, who has purchased a vehicle, with information such as captured images of the vehicle being assembled and location information on the vehicle being transported.

### CITATION LIST

### Patent Literature

PTL 1: JP 2002-297954 A

### SUMMARY

Vehicles purchased by users are not immediately delivered to the users, even after the vehicles have been manufactured and have arrived at dealers.

For example, due to work for installing dealer options, the vehicles having arrived at the dealers are delivered to the users after a lapse of a certain number of days.

The users who have purchased the vehicles can confirm that the purchased vehicles have arrived at the dealers, through contacts with sales representatives, applications that allow the users to check on progress, or the like. When the vehicles are not delivered for some time after the users know that the purchased vehicles have arrived at the dealers, the users may feel stressed about waiting for the vehicles to be delivered.

It would be helpful to reduce stress on users waiting for delivery of vehicles that have arrived at dealers.

An information processing apparatus according to the present disclosure includes a controller configured to:
acquire user information regarding a user who has purchased a vehicle;
generate at least one content according to the user information; and
transmit the content to a terminal apparatus of the user at a predetermined timing, in a period of time from when the vehicle has arrived at a dealer until when the vehicle is delivered to the user.

A program according to the present disclosure is configured to cause a computer to execute operations, the operations including:
acquiring user information regarding a user who has purchased a vehicle;
generating at least one content according to the user information; and
transmitting the content to a terminal apparatus of the user at a predetermined timing, in a period of time from when the vehicle has arrived at a dealer until when the vehicle is delivered to the user.

An information processing method according to the present disclosure is an information processing method by an information processing apparatus, the information processing method including:
acquiring user information regarding a user who has purchased a vehicle;
generating at least one content according to the user information; and
transmitting the content to a terminal apparatus of the user at a predetermined timing, in a period of time from when the vehicle has arrived at a dealer until when the vehicle is delivered to the user.

According to the present disclosure, it is possible to reduce stress on users waiting for delivery of vehicles that have arrived at dealers.

### BRIEF DESCRIPTION OF THE DRAWINGS

In the accompanying drawings:

FIG. 1 is a diagram illustrating a configuration of an information processing system according to an embodiment of the present disclosure;

FIG. 2 is a block diagram illustrating a configuration of an information processing apparatus according to the embodiment of the present disclosure;

FIG. 3 is a block diagram illustrating a configuration of a terminal apparatus according to the embodiment of the present disclosure;

FIG. 4 is a diagram illustrating an example of the terminal apparatus displaying a content; and

FIG. 5 is a flowchart illustrating operations of the information processing system according to the embodiment of the present disclosure.

### DETAILED DESCRIPTION

An embodiment of the present disclosure will be described below with reference to the drawings.

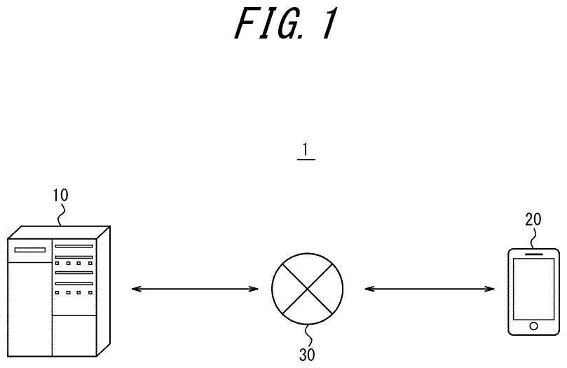

FIG. 1 is a diagram illustrating a configuration of an information processing system 1 according to the embodiment of the present disclosure. The configuration and outline of the information processing system 1 according to the embodiment of the present disclosure will be described with reference to FIG. 1.

The information processing system 1 includes an information processing apparatus 10 and a terminal apparatus 20. The information processing apparatus 10 and the terminal apparatus 20 are communicably connected via a network 30. The network 30 may be a network including a mobile communication network, the Internet, or the like.

Although one information processing apparatus 10 is illustrated in FIG. 1, the number of information processing apparatuses 10 may be two or more. Also, although one terminal apparatus 20 is illustrated in FIG. 1, the number of terminal apparatuses 20 may be two or more.

The information processing apparatus 10 is, for example, a dedicated computer configured to function as a server. The information processing apparatus 10 may be a general purpose personal computer (PC). The information processing apparatus 10 can communicate with the terminal apparatus 20 via the network 30.

The information processing apparatus 10 acquires user information regarding a user who has purchased a vehicle. The information processing apparatus 10 generates at least one content according to the acquired user information. The information processing apparatus 10 transmits the generated content to the terminal apparatus 20 of the user at a predetermined timing, in a period of time from when the vehicle purchased by the user has arrived at a dealer until when the vehicle is delivered to the user. Details of processes performed by the information processing apparatus 10 will be described below.

The information processing apparatus 10 may be installed in the dealer, in a building of a company that sells vehicles, or the like. Alternatively, the information processing apparatus 10 may be installed in other facilities. Here, the dealer is a distributor that sells vehicles.

The terminal apparatus 20 is a terminal apparatus in the possession of the user who has purchased the vehicle.

The terminal apparatus 20 may be, for example, a smartphone, tablet, or PC. The terminal apparatus 20 can communicate with the information processing apparatus 10 via the network 30.

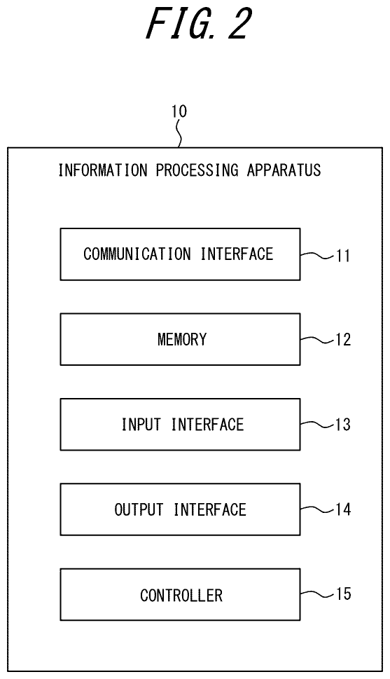

A configuration of the information processing apparatus 10 according to the embodiment of the present disclosure will be described with reference to FIG. 2.

The information processing apparatus 10 includes a communication interface 11, a memory 12, an input interface 13, an output interface 14, and a controller 15.

The communication interface 11 includes a communication module that connects to the network 30. For example, the communication interface 11 may include a communication module corresponding to a local area network (LAN). In this embodiment, the information processing apparatus 10 is connected to the network 30 via the communication interface 11. The communication interface 11 transmits and receives various types of information via the network 30. The communication interface 11 can communicate with the terminal apparatus 20 via the network 30.

For example, the memory 12 is, but is not limited to, a semiconductor memory, a magnetic memory, an optical memory, or the like. The memory 12 may function as, for example, a main memory, an auxiliary memory, or a cache memory. The memory 12 stores any information used for operations of the information processing apparatus 10. For example, the memory 12 may store a system program, an application program, various types of information received by the communication interface 11, and the like. The information stored in the memory 12 may, for example, be updated with information received from the network 30 via the communication interface 11. A portion of the memory 12 may be installed externally to the information processing apparatus 10. In this case, the externally installed portion of the memory 12 may be connected to the information processing apparatus 10 via any appropriate interface.

The input interface 13 includes one or more input interfaces for detecting user input and acquiring input information based on user operation. For example, the input interface 13 includes, but is not limited to, a physical key, a capacitive key, a touch screen integrally provided with a display of the output interface 14, a microphone that accepts audio input, or the like.

The output interface 14 includes one or more output interfaces for outputting information to notify a user. For example, the output interface 14 includes, but is not limited to, a display for outputting information as images, a speaker for outputting information as audio, or the like.

The controller 15 includes at least one processor, at least one dedicated circuit, or a combination thereof. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 15 executes processes related to the operations of the information processing apparatus 10 while controlling components of the information processing apparatus 10.

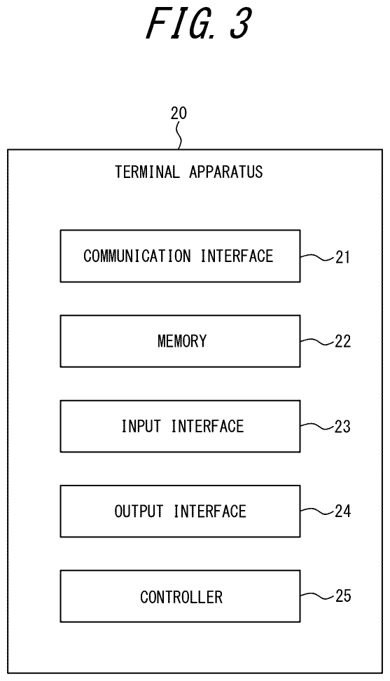

A configuration of the terminal apparatus 20 according to the embodiment of the present disclosure will be described with reference to FIG. 3.

The terminal apparatus 20 includes a communication interface 21, a memory 22, an input interface 23, an output interface 24, and a controller 25.

The communication interface 21 includes a communication module that connects to the network 30. For example, the communication interface 21 may include a communication module compliant with mobile communication standards such as Long Term Evolution (LTE), 4th Generation (4G), and 5th Generation (5G). In this embodiment, the terminal apparatus 20 is connected to the network 30 via the communication interface 21. The communication interface 21 transmits and receives various types of information via the network 30. The communication interface 21 can communicate with the information processing apparatus 10 via the network 30.

For example, the memory 22 is, but is not limited to, a semi-conductor memory, a magnetic memory, an optical memory, or the like. The memory 22 may function as, for example, a main memory, an auxiliary memory, or a cache memory. The memory 22 stores any information used for operations of the terminal apparatus 20. For example, the memory 22 may store a system program, an application program, various types of information received by the communication interface 21, and the like. The information stored in the memory 22 may, for example, be updated with information received from the network 30 via the communication interface 21. A portion of the memory 22 may be installed externally to the terminal apparatus 20. In this case, the externally installed portion of the memory 22 may be connected to the terminal apparatus 20 via any appropriate interface.

The input interface 23 includes one or more input interfaces for detecting user input and acquiring input information based on user operation.

For example, the input interface 23 includes, but is not limited to, a physical key, a capacitive key, a touch screen integrally provided with a display of the output interface 24, a microphone that accepts audio input, or the like.

The output interface 24 includes one or more output interfaces for outputting information to notify the user. For example, the output interface 24 includes, but is not limited to, a display for outputting information as images, a speaker for outputting information as audio, or the like.

The controller 25 includes at least one processor, at least one dedicated circuit, or a combination thereof. The processor is a general purpose processor such as a CPU or a GPU, or a dedicated processor that is dedicated to specific processing. The dedicated circuit is, for example, an FPGA or an ASIC. The controller 25 executes processes related to the operations of the terminal apparatus 20 while controlling components of the terminal apparatus 20.

### (Operations of Information Processing System)

Operations of the information processing system 1 illustrated in FIG. 1 will be described with reference to FIGS. 2 and 3 and the like.

The controller 15 of the information processing apparatus 10 acquires user information regarding a user who has purchased a vehicle. The controller 15 may acquire the user information by input operation to the input interface 13, or may acquire the user information via the communication interface 11 from a terminal apparatus operated by an employee of the dealer.

When the user information is acquired from the terminal apparatus operated by the employee, the communication interface 11 of the information processing apparatus 10 receives the user information transmitted from the terminal apparatus operated by the employee. The controller 15 acquires, via the communication interface 11, the user information transmitted from the terminal apparatus operated by the employee.

Alternatively, the controller 15 may acquire the user information from the terminal apparatus 20 in the possession of the user who has purchased the vehicle. In this case, the user operates the input interface 23 of the terminal apparatus 20 to input the user information. The controller 25 transmits the user information, which is input to the input interface 23, to the information processing apparatus 10 via the communication interface 21. The communication interface 11 of the information processing apparatus 10 receives the user information transmitted by the terminal apparatus 20. The controller 15 receives the user information, which is transmitted by the terminal apparatus 20, via the communication interface 11.

For example, the user information on the user who has purchased the vehicle may contain information on the user's family structure, information on the user's pets, information on the user's family age, information on the user's family physique, information on the user's hobbies, information on the user's interests, and/or information on intended use of the vehicle.

The controller 15 may acquire the user information at a time when the user purchases the vehicle. Here, the time when the user purchases the vehicle may be before or after the user signs a contract to purchase the vehicle.

Alternatively, the controller 15 may acquire the user information some time after the user has purchased the vehicle. In this case, for example, the controller 15 may acquire the user information from the terminal apparatus 20. For example, the controller 15 may acquire the user information from the terminal apparatus 20 by the user operating an application running on the terminal apparatus 20.

Upon acquiring the user information, the controller 15 generates at least one content according to the user information. The content generated by the controller 15 is a content that the user, who is waiting for delivery of the purchased vehicle, views on the terminal apparatus 20.

Upon generating the content, the controller 15 transmits, via the communication interface 11, the generated content to the terminal apparatus 20 of the user at a predetermined timing, in a period of time from when the vehicle has arrived at the dealer until when the vehicle is delivered to the user.

The communication interface 21 of the terminal apparatus 20 receives the content transmitted by the controller 15 of the information processing apparatus 10. The controller 25 acquires, via the communication interface 21, the content transmitted by the controller 15 of the information processing apparatus 10.

The controller 25 controls the output interface 24 to display the acquired content. This allows the user, who has purchased the vehicle, to view the content related to the user information.

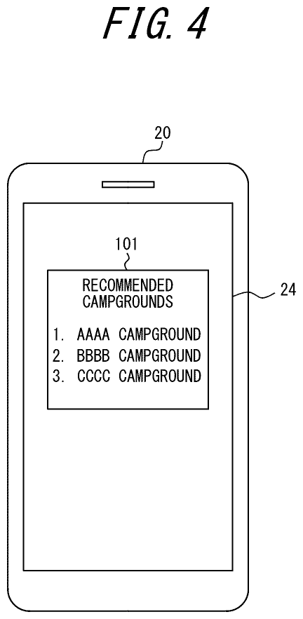

FIG. 4 illustrates an example of the terminal apparatus 20 displaying the content. In the example illustrated in FIG. 4, a content 101 related to recommended campgrounds is displayed on the output interface 24 of the terminal apparatus 20. In this case, the content 101 related to the recommended campgrounds may be, for example, the content that has been generated by the controller 15 of the information processing apparatus 10 based on the fact that the user information contains information that the user's hobby is camping.

The controller 15 of the information processing apparatus 10 generates various contents according to the user information. The contents may be contents including text, images, video, or the like. The contents are preferably of high interest to the user who is waiting for delivery of the vehicle.

For example, when the user information contains information on the user's family structure, i.e., information that the user has a child, the contents may include information about recommended installation locations for child seats, how to properly install the child seats, and the like. In this case, the contents may be, for example, 3D images of the vehicle indicating the installation locations for the child seats.

For example, when the user information contains information on the user's pets, i.e., information that the user has a dog, the contents may include information about how to clean pet hair in the car.

For example, when the user information contains information on the user's family age, i.e., information that the user's family includes an elderly person, the contents may include information about seating positions in which elderly people can sit comfortably. For example, when the vehicle has three rows of seats and the third row is narrow, the contents may include information recommending that elderly people should sit in the second row.

For example, when the user information contains information on the user's family physique, i.e., information that the user's family includes a tall person, the contents may include information about how to properly adjust seating positions.

For example, when the user information contains information on the user's hobbies, i.e., information that the user's hobby is golf, the contents may include information about how to load golf bags.

For example, when the user information contains information on the user's interests, i.e., information that the user is interested in a car navigation system, the contents may include information about how to conveniently use the car navigation system.

For example, when the user information contains information on intended use of the vehicle, i.e., information that the intended use includes travel, the contents may include information about recommended travel destinations.

The controller 15 transmits the generated contents to the terminal apparatus 20 at the predetermined timing, in the period of time from when the vehicle has arrived at the dealer until when the vehicle is delivered to the user.

The predetermined timing may include, for example, periodic timings. The periodic timings may be, for example, once a day, or several times at set times during a day.

Thus, when the controller 15 transmits the contents periodically, the user can view the contents displayed on the terminal apparatus 20 on a regular basis. This allows the user to view the contents on a regular basis, while the use is waiting for delivery of the vehicle, thus reducing stress on the user while the user is waiting for delivery of the vehicle that has arrived at the dealer.

Alternatively, the predetermined timing may include, for example, the timing at which a dealer option is installed on the vehicle. In this case, for example, the controller 15 may transmit, at the timing when a car navigation system is installed in the vehicle, the installation of the car navigation system and the contents including information about how to conveniently use the car navigation system, to the terminal apparatus 20.

When the controller 15 transmits the contents at the timing when the dealer option is installed in the vehicle, as described above, the user can check the progress of the dealer option being installed in the vehicle, and can also view the interesting contents about the dealer option. Therefore, the user can reduce stress while waiting for delivery of the vehicle that has arrived at the dealer.

When generating the contents, the controller 15 may combine content materials stored in the memory 12 to generate the contents. The content materials may be materials to generate the contents, such as text, images, or video.

Upon acquiring the user information, the controller 15 generates the contents by combining content materials related to information contained in the user information. For example, when the user information includes information that the user has a dog, the controller 15 generates the contents by combining content materials related to dogs. When a single content material can be used as-is as a content, the controller 15 may generate the content from the single content material, without combining multiple content materials.

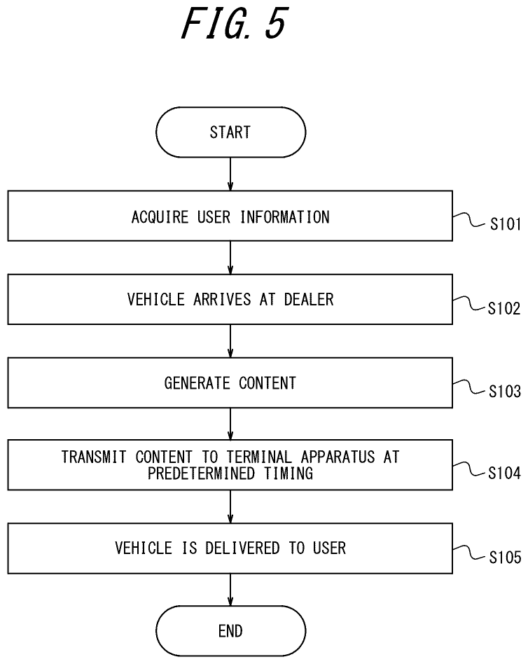

Operations of the information processing apparatus 10 will be described with reference to the flowchart in FIG. 5.

Step S101: The controller 15 of the information processing apparatus 10 acquires user information on a user who has purchased a vehicle.

Step S102: The vehicle purchased by the user arrives at the dealer.

Step S103: The controller 15 generates at least one content according to the user information. In this case, the controller 15 may generate the content by combining content materials related to information contained in the user information.

Step S104: Upon generating the content, the controller 15 transmits the generated content to the terminal apparatus 20 of the user at a predetermined timing, in a period of time from when the vehicle has arrived at the dealer until when the vehicle is delivered to the user.

Step S105: When the vehicle is delivered to the user, the controller 15 terminates the process of transmitting the content to the terminal apparatus 20.

As described above, in the information processing apparatus 10 according to the present embodiment, the controller 15 acquires user information on a user who has purchased a vehicle, generates at least one content according to the acquired user information, and transmits the generated content to the terminal apparatus 20 of the user at a predetermined timing, in a period of time from when the vehicle has arrived at the dealer until when the vehicle is delivered to the user. This allows the user who has purchased the vehicle to view the content related to the user information at the predetermined timing, in the period of time from when the purchased vehicle has arrived at the dealer until when the vehicle is delivered to the user. Therefore, the user can spend, without being bored, waiting time from when the vehicle has arrived at the dealer until when the vehicle is delivered. In addition, the user can spend the waiting time from when the vehicle has arrived at the dealer until when the vehicle is delivered, without feeling anxious that the delivery may have been forgotten. Therefore, the information processing apparatus 10 according to the present embodiment can reduce stress on the user who is waiting for delivery of the vehicle that has arrived at the dealer.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

For example, some of the processing operations executed in the information processing apparatus 10 in the above embodiment may be executed in the terminal apparatus 20. Also, some of the processing operations executed in the terminal apparatus 20 in the above embodiment may be executed in the information processing apparatus 10.

For example, a configuration that causes a general purpose electronic device such as a smartphone or a computer to function as the information processing apparatus 10 according to the embodiment described above is possible. Specifically, a program in which processes for realizing the functions of the information processing apparatus 10 or the like according to the embodiment are written may be stored in a memory of the electronic device, and the program may be read and executed by a processor of the electronic device. Accordingly, in an embodiment, the present disclosure can also be implemented as a program executable by a processor.

Examples of some embodiments of the present disclosure are described below. However, it should be noted that the embodiments of the present disclosure are not limited to these examples.
[Appendix 1] An information processing apparatus comprising a controller configured to:
   acquire user information regarding a user who has purchased a vehicle;
   generate at least one content according to the user information; and
   transmit the content to a terminal apparatus of the user at a predetermined timing, in a period of time from when the vehicle has arrived at a dealer until when the vehicle is delivered to the user.
[Appendix 2] The information processing apparatus according to appendix 1, further comprising a memory configured to store content materials to generate the content,
   wherein the controller is configured to generate the content by combining the content materials related to information contained in the user information.
[Appendix 3] The information processing apparatus according to appendix 1 or 2, wherein the user information includes information on family structure, information on a pet, information on age, information on physique, information on a hobby, information on an interest, and/or information on intended use of the vehicle.
[Appendix 4] The information processing apparatus according to any one of appendices 1 to 3, wherein the controller is configured to acquire the user information at a time when the user purchases the vehicle.
[Appendix 5] The information processing apparatus according to any one of appendices 1 to 4, wherein the controller is configured to acquire the user information from the terminal apparatus of the user.
[Appendix 6] The information processing apparatus according to any one of appendices 1 to 5, wherein the predetermined timing includes periodic timings.
[Appendix 7] The information processing apparatus according to any one of appendices 1 to 6, wherein the predetermined timing includes a timing at which a dealer option is installed in the vehicle.
[Appendix 8] A program configured to cause a computer to execute operations, the operations comprising:
   acquiring user information regarding a user who has purchased a vehicle;
   generating at least one content according to the user information; and
   transmitting the content to a terminal apparatus of the user at a predetermined timing, in a period of time from when the vehicle has arrived at a dealer until when the vehicle is delivered to the user.
[Appendix 9] The program according to appendix 8, wherein the generating of the content includes generating the content by combining content materials related to information contained in the user information.
[Appendix 10] The program according to appendix 8 or 9, wherein the user information includes information on family structure, information on a pet, information on age, information on physique, information on a hobby, information on an interest, and/or information on intended use of the vehicle.
[Appendix 11] The program according to any one of appendices 8 to 10, wherein the acquiring of the user information includes acquiring the user information at a time when the user purchases the vehicle.
[Appendix 12] The program according to any one of appendices 8 to 11, wherein the acquiring of the user information includes acquiring the user information from the terminal apparatus of the user.
[Appendix 13] The program according to any one of appendices 8 to 12, wherein the predetermined timing includes periodic timings.
[Appendix 14] The program according to any one of appendices 8 to 13, wherein the predetermined timing includes a timing at which a dealer option is installed in the vehicle.
[Appendix 15] An information processing method by an information processing apparatus, the information processing method comprising:
   acquiring user information regarding a user who has purchased a vehicle;
   generating at least one content according to the user information; and
   transmitting the content to a terminal apparatus of the user at a predetermined timing, in a period of time from when the vehicle has arrived at a dealer until when the vehicle is delivered to the user.
[Appendix 16] The information processing method according to appendix 15, wherein the generating of the content includes generating the content by combining content materials related to information contained in the user information.
[Appendix 17] The information processing method according to appendix 15 or 16, wherein the user information includes information on family structure, information on a pet, information on age, information on physique, information on a hobby, information on an interest, and/or information on intended use of the vehicle.
[Appendix 18] The information processing method according to any one of appendices 15 to 17, wherein the acquiring of the user information includes acquiring the user information at a time when the user purchases the vehicle.
[Appendix 19] The information processing method according to any one of appendices 15 to 18, wherein the acquiring of the user information includes acquiring the user information from the terminal apparatus of the user.
[Appendix 20] The information processing method according to any one of appendices 15 to 19, wherein the predetermined timing includes periodic timings.

1. An information processing apparatus comprising a controller configured to:
acquire user information regarding a user who has purchased a vehicle;
generate at least one content according to the user information; and
transmit the content to a terminal apparatus of the user at a predetermined timing, in a period of time from when the vehicle has arrived at a dealer until when the vehicle is delivered to the user.

2. The information processing apparatus according to claim 1, further comprising a memory configured to store content materials to generate the content,
wherein the controller is configured to generate the content by combining the content materials related to information contained in the user information.

3. The information processing apparatus according to claim 1, wherein the user information includes information on family structure, information on a pet, information on age, information on physique, information on a hobby, information on an interest, and/or information on intended use of the vehicle.

4. The information processing apparatus according to claim 1, wherein the controller is configured to acquire the user information at a time when the user purchases the vehicle.

5. The information processing apparatus according to claim 1, wherein the controller is configured to acquire the user information from the terminal apparatus of the user.

6. The information processing apparatus according to claim 1, wherein the predetermined timing includes periodic timings.

7. The information processing apparatus according to claim 1, wherein the predetermined timing includes a timing at which a dealer option is installed in the vehicle.

8. A non-transitory computer readable medium storing a program configured to cause a computer to execute operations, the operations comprising:
acquiring user information regarding a user who has purchased a vehicle;
generating at least one content according to the user information; and
transmitting the content to a terminal apparatus of the user at a predetermined timing, in a period of time from when the vehicle has arrived at a dealer until when the vehicle is delivered to the user.

9. The non-transitory computer readable medium according to claim 8, wherein the generating of the content includes generating the content by combining content materials related to information contained in the user information.

10. The non-transitory computer readable medium according to claim 8, wherein the user information includes information on family structure, information on a pet, information on age, information on physique, information on a hobby, information on an interest, and/or information on intended use of the vehicle.

11. The non-transitory computer readable medium according to claim 8, wherein the acquiring of the user information includes acquiring the user information at a time when the user purchases the vehicle.

12. The non-transitory computer readable medium according to claim 8, wherein the acquiring of the user information includes acquiring the user information from the terminal apparatus of the user.

13. The non-transitory computer readable medium according to claim 8, wherein the predetermined timing includes periodic timings.

14. The non-transitory computer readable medium according to claim 8, wherein the predetermined timing includes a timing at which a dealer option is installed in the vehicle.

15. An information processing method by an information processing apparatus, the information processing method comprising:
acquiring user information regarding a user who has purchased a vehicle;
generating at least one content according to the user information; and
transmitting the content to a terminal apparatus of the user at a predetermined timing, in a period of time from when the vehicle has arrived at a dealer until when the vehicle is delivered to the user.

16. The information processing method according to claim 15, wherein the generating of the content includes generating the content by combining content materials related to information contained in the user information.

17. The information processing method according to claim 15, wherein the user information includes information on family structure, information on a pet, information on age, information on physique, information on a hobby, information on an interest, and/or information on intended use of the vehicle.

18. The information processing method according to claim 15, wherein the acquiring of the user information includes acquiring the user information at a time when the user purchases the vehicle.

19. The information processing method according to claim 15, wherein the acquiring of the user information includes acquiring the user information from the terminal apparatus of the user.

20. The information processing method according to claim 15, wherein the predetermined timing includes periodic timings.
